(19) United States
(12) Patent Application Publication
(10) Pub. No.: US 2023/0233304 A1
(43) Pub. Date: Jul. 27, 2023

(54) Teethsweep-T

(71) Applicant: Timothy Dewayne Ford, Oklahoma City, OK (US)

(72) Inventor: Timothy Dewayne Ford, Oklahoma City, OK (US)

(21) Appl. No.: 17/582,397

(22) Filed: Jan. 24, 2022

(51) Int. Cl. A61C 17/34

(52) U.S. Cl. CPC A61C 17/349; A61C 17/3436

(57) ABSTRACT

For many years people have been great need of an oral cleaning device that cleans thoroughly, quickly, and efficiently. In designing my Teethsweep-T electric toothbrush all of these factors and more were addressed and remitted. This hand held cleaning device reduces the average brushing time by more than fifty percent. My Unique Sequential Alignment of Gears, found in no other electric toothbush, allows for the individual three hundred sixty (360) rotation of four individual circular sets of bristles. Other electric oral cleaning devices uses sonic motion or pulse with bristles moving up and down; and side to side when in operation. While dentists recommended brushing in a circular motion, My Teethsweep-T electric toothbrush uses circular motion for thorough cleaning when in operation.

[symbol] FIG. 1 is a display of the Teethsweep-T electric toothbrush, and a inside view of all of it's movinig and working parts, As described in the text of this Description below.

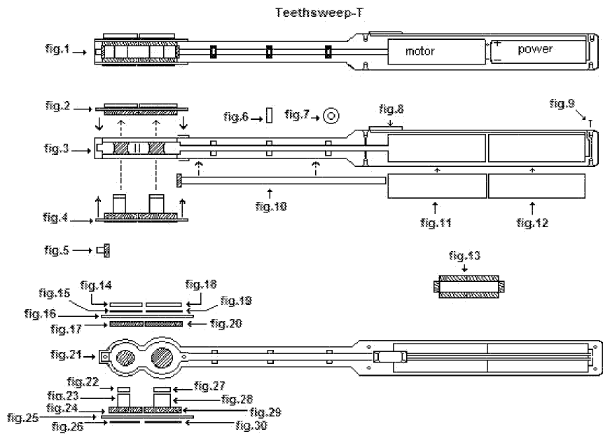

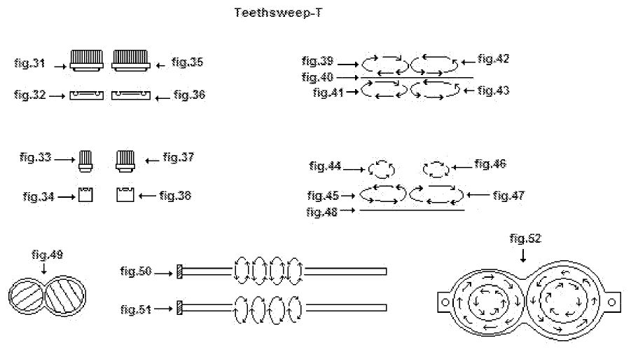

FIG. 2 is a display of the Upper Plateform of the Teethsweep-T electric toothbrush and all of it's working parts, it houses the First Outter Replaceable Toothbrush Bristles, the First Outter Toothbrush Bristles Rack, the First Outter Gear, the Secuond Outter Replaceable Toothbrush Bristles, the Second Outter Toothbrush Bristles Rack, and the Secound Outter Gear.

FIG. 3 is a side view display of the Toothbrush Base, it houses all the moving and working parts of the Teethsweep-T electric toothbrush.

FIG. 4 is a display of the Lower Plateform, of the Teethsweep-T electric toothbrush and all of it's working parts, It houses the First Inner Replaceable Toothbrush Bristles, the First Inner Toothbrush Bristles Rack, the First Inner Gear, the Second Inner Replaceable Toothbrush Briistles, the Second Inner Toothbrush Bristles Rack, and the Second Inner Gear.

FIG. 5 is a display of the Short Geared Shaft, it is in direct contact with the First Outer Gear and the First Inner Gear during operation of the Teethsweep-T electic toothbrush. The Short Geared Shaft is parts of the Unique Sequential allignment of gears which enable the movement of all of the replaceable toothbrush bristles.

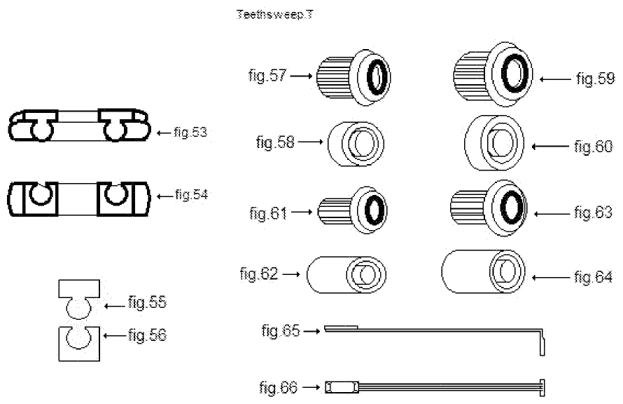

FIG. 6 is a display of the side view of the Bushing of the Teethsweep-T, it enables smooth rotation and turnning of the Long Geared Shaft.

FIG. 7 is another view of FIG. 6 showing a front view, it enables the smooth rotation of the Long geared Shaft.

FIG. 8 is a display of the OFF and ON Operating Powering Switch allowing reverse it supplies power from the power supply to the Electric Motor, which enable all the movement of all the working parts of the Teethsweep-T electric toothrush.

FIG. 9 is a display of one of the screws wihich help secures the Teethsweep-T eletric toothbush and all of its moving parts inside.

FIG. 10 is a display of the Long Geared Shaft, the gear part of the Long Geared Shaft it is in direct contact with the Second Outter Gear and the Second Inner Gear while the shaft part of the Long Geared Shaft is connected to the electric motor, which enables movement of all the moving parts of the Teethsweep-T.

FIG. 11 is a representation of the Eleectric Motor part of Teethsweep-T electric toothbrush. The Electric motor is in direct contact with the 12 volts power supply, it is also in direct contact with FIG. 10 the Long Geared Shaft.

FIG. 12 is a representation of the 12 volts power supply of the Teethsweep-T electric toothbrush.

FIG. 13 is a display of the Unique Sequenctial Alignment of Gears which enable the movement of the First Inner Toothbrush Bristles, First Outter toothbrush Bristles, the Second Inner Toothbrush Bristles, and the Second Outter Toothbrush bristles. of the Teethsweep-T electric toothbrush.

FIG. 14 is a display of the First Outter Toothbrush Bristles, it is a replaceable cleaning part located and mounted on the top of the First Outter Toothbrush Bristle Rack by means of the FIG. 53 the Protruding Lock in place maganism and FIG. 54 the Recessive Lock in place meganism.

FIG. 15 is a display of the First Outter Toothbrush Bristles Rack, it is located of top of the First Outter Gear and directly connected to the First Outter Toothbrush Bristles on top and the First Outter Gear on bottom.

FIG. 16 is a display of the Upper Plateform wihich houses the First Outter toothbrush bristles, the First Outter toothbrush Bristles Rack the First Outter Gear; It also houses the Second Outter toothbrush Bristles, the Second Out toothbrush Bristles Rack, and the Second Outter toothbrush Gear.

FIG. 17 is a display of the Frist Outter Gear, it enables movement of First Outter toothbrush Bristles, and the First Outter toothbrush Bristles Rack.

FIG. 18 is a display of the Second Outter toothbrush Bristles, it is a replaceable cleaning part located and mounted on top of the Second Outter Toothbrush Bristles Rack by means of FIG. 53 Protruding Lock in place meganism and FIG. 54 the Recessive Lock in place maganism.

FIG. 19 is a display of Second Outter toothbrush Bristles Rack, it is located. on top of the Second Outter Gear and is directly connected to the Second Outter Toothbrush Bristles on top and the Second Outter Gear on bottom.

FIG. 20 is a display of the Second Outter Gear, it enables movement of the Second Outter Toothbrush Bristles, and the Second Outter Toothbrush Bristles Rack.

FIG. 21 corresponds with FIG. 3 it displays a top view of the Toothbrush base, it houses all of the moving and working parts of the Teethsweep-t electric toohbrush.

FIG. 22 is a display of the First Inner Toothbrush Bristles, it is a replaceable cleaning part located and mounted on top of the First Inner Toothbrush Rack by means of FIG. 53 Protruding Lock in place meganism and FIG. 54 the Recessive Lock in place meganism.

FIG. 23 is a display of the First Inner Toothbrush Bristles Rack, it is located on top of the First Inner Toothbrush Bristles Gear.and directly connected to the First Outter Toothbrush Bristles on the top and the First Inner toothbrush Gear on the bottom.

FIG. 24 is a display of the First Inner Toothbrush Brisles Gear, it enables movement of the First Inner Toothbrush bristles and the First Inner Toothbrush Bristles Rack, and the First Tongue Cleaner.

FIG. 25 is a display of the Lowwer Plateform which houses the First Inner Toothbrush Bristles, the First Inner Toothbrush Rack and the First inner Toothbrush Bristles Gear; it also houses the Second Inner Toothbrush Bristles, the Second Inner Toothbrush Bristles Rack, and the Second Inner Toothbrush Gear along with the First Tongue Cleaner and the Second Tongue Cleaner.

FIG. 26 is a display of the First Tougue Cleaner, it is a cleaning part located on the bottom First Inner Toothbrush Gear.

FIG. 27 is a display of the Second Inner Toothbrush Bristles, it is a replaceable cleaning part, located and mounted on top of the Second Inner Toothbrush Bristles Rack by means of FIG. 53 Protruding Lock in place maganism and FIG. 54 Recessive Lock in place maganism.

FIG. 28 is a display of the Second Inner Toothbrush Brisltes Rack, it is located on top of the Second Inner Toothbrush Bristles Gear and directly connected to the Second Inner Toothbrush bristles Gear on the bottom.

FIG. 29 is a display of the Second Inner Toothbrush Bristles Gear, it enables the movement of the Second Inner Toothbrush Bristles, and the Second Inner Toothbrush Bristles Rack, and the Second Toothbrush Tongue Cleaner.

FIG. 30 is a display the Second Tongue Cleaner, it is cleaning part located on the bottom of the Second Inner toothbrush Gear.

FIG. 31 is a detailed display of FIG. 14 the First Outter Toothbrush Bristles, it is a replaceable cleaning part of the Teethsweep-T.

FIG. 32 is a detaied display of FIG. 15 the First outter Toothbrush Bristles Rack, it corresponds with the description for FIG. 15.

FIG. 33 is a detailed display of FIG. 22 the First Inner Toothbrush Bristles, it is a replaceable cleaning part of the Teethsweep-T.

FIG. 34 is a detailed display of FIG. 23 the First Inner Toothbrush Bristles Rack, it corresponds with the description for FIG. 23.

FIG. 35 is a detailed display of FIG. 18 the Second Outter Toothbrush Bristles, it is a replaceable cleaning part of the Teethsweep-T.

FIG. 36 is a detailed display of FIG. 19 the Second Outter Toothbrush Bristles Rack it corresponds with the description for FIG. 19.

FIG. 37 is a detailed display of FIG. 27 the Second Inner Toothbrush Bristles, it is a replaceable cleaning part of the Teethsweep-T.

FIG. 38 is a detailed display of FIG. 28 the Second Inner Toothbrush Bristles Rack, it corresponds with the description for FIG. 28.

FIG. 39 corresponds to FIG. 14 with the circular arrows representing the 360 degrees motion of rotation of FIG. 14 the First Outter Toothbrush Bristles while the Teethsweet-T is in operation.

FIG. 40 is a display of FIG. 16 the Upper plateform and corresponds with the description for FIG. 16.

FIG. 41 corresponds to FIG. 17 with the circular arrows representing the 360 degree motion of rotation of FIG. 17 the First Outter Gear.

FIG. 42 corresponds to FIG. 18 with the circular arrows representing the 360 degree motion of rotation of FIG 18 the Second Outter Toothbush Bristles while the Teethsweep-T is in operation.

FIG. 43 coresponds to FIG. 20 with the curcular arrows representing the 360 degree motion of rotation of FIG. 20 the Second Outter Gear while the Teethsweep-T is in operation.

FIG. 44 corresponds to FIG. 22 with the circular arrows representing the 360 degree motion of rotation of FIG. 22 the First Inner Toothbrush Bristles while the Teethsweep-T is in operation.

FIG. 45 corresponds to FIG. 24 with the circular arrows representing the 360 degree motion of rotation of FIG. 24 the First Inner Gear while the Teethsweep-T is in operation.

FIG. 46 corresponds to FIG. 27 with the circular arrows representing the 360 degree motion of rotation of FIG. 27 the Second Inner toothbrush Bristles while the Teethsweep-T is in operation.

FIG. 47 corresponds with FIG. 29 with the circular arrows representing the 360 degree motion of rotation of FIG. 29 the Second Inner Gear while the Teethsweep-T is in operation.

FIG. 48 is a display of FIG. 25 the Lowwer Plateform and corresponds with the description of FIG. 25.

FIG. 49 is a bottom view display of FIG. 4 showing FIG. 26 the First Tongue Cleaner and FIG. 30 the Second Tongue Cleaner.

FIG. 50 corresponds to FIG. 10 with the circular arrows representing the 360 degree motion Θf rotation of FIG. 10 the Long Geared Shaft while the Teethsweep-T is in operating in forward.

FIG. 51 corresponds to FIG. 10 with the circular arrows representing the 360 degree motion of rotation of FIG. 10 the Long Geared Shaft while the Teethsweep-T is operating in reverse.

FIG. 52 is a display of the claim of the Teethsweep-T electric toothbrush, showing a top view of FIG. 14; FIG. 18; FIG. 22; and FIG. 27 with circular arrows representing 360 degree rotation of FIG. 14 the First Outter Toothbrush Bristles, FIG. 18 thr Second Outter Toothbrush Bristles; FIG. 22 the First Inner Toothbrush Bristles, and FIG. 27 the Second Inner Toothbrush Bristles while the Teethsweep-T is in operation.

FIG. 53 is a detailed three dimensional display of the Protruding Lock in place maganism, there is one located under the bottom of FIG. 14; FIG. 18, FIG. 22, and FIG. 27: The Protruding Lock maganism helps secures the Toothbrush Bristles to the Toothbrush Bristles Rack, snaps in place to the Recessive Lock in place maganism.

FIG. 54 is a detailed dimensional display of the Recessive Lock in place meganism, there is one located on the top of FIG. 15; FIG. 19; FIG. 23; and FIG. 28: The Recessive Lock in place meganism helps secures the Toothbrush Bristles Rack to the Toothbrush Bristles, it snaps in place to the Protruding Lock in place meganism.

FIG. 55 in is a detailed display of FIG. 53 and corresponds with the description for FIG. 53 the Protruding Lock in plae meganism.

FIG. 56 is a detailed display of FIG. 54 and corresponds with the description for FIG. 54 the Recessive Lock in place meganism

FIG. 57 corresponds with FIG. 31 it shows a detailed three dimensional display of the bottom FIG. 14 the First Outter Toothbrush Bristles with an arrow touching FIG. 53 the Protruding Lock in place meaganism.

FIG. 58 corresponds with FIG. 32 it shows a detailed three dimensional display of top of FIG. 15 the First Outter Toothbrush Bristles Rack with an arrow touching FIG. 54 the Recessive Lock in place meganisn.

FIG. 59 corresponds with FIG. 35 it shows a detailed three dimensional display of the bottom of FIG. 18 the Second Outter Toothbrush Bristles with an arrow touching FIG. 53 the Protruding Lock in place meganism.

FIG. 60 corresponds with FIG. 36 it shows a detailed three dimensional display of the top of FIG. 19 the Second Outter Toothbrsh Brisltles Rack with an arrow touching FIG. 54 the Recessive Lock in place meganism.

FIG. 61 corresponds with FIG. 33 it shows a detailed three dimensional display of the bottom of FIG. 22 the First Inner Toothbrush Brisltes with an arrow touching FIG. 53 the Protuding lock in place meganism.

FIG. 62 corresponds with FIG. 34 it shows a detailed three dimensional display of top FIG. 23 the Frist Inner Toothbrush Bristles Rack with an arrow touching FIG. 54 the Recessive Lock in place meganism.

FIG. 63 corresponds with FIG. 37 it shows a detailed three dimensional display of bottom of FIG. 27 the Second Inner Toothbrush Bristles with an arrow touching FIG. 53 the Protruding Lock in place meaganism.

FIG. 64 corresponds with FIG. 38 it shows a detailed three dimesiional display of the top of FIG. 28 the second Inner Toothbrush Brisltes Rack with an arrow touching FIG. 54 the Recessive lock in place meganism.

FIG. 65 is a detailed side view display of FIG. 8 the Off and ON Operating Power Switch and corresponds with the description for FIG. 8.

FIG. 66 is a detailed top view display of FIG. 8 the Off and On Operating Power Switch and corresponds with the description for FIG. 8.

1. The design of the Teethsweep-T electric toothbrush and all of it's moving and working parts as illustrated in the drawings 1-66, and described in the Desription 1-66. The first of it's kind, my newly designed Teethsweep-T electric toothbrush features 4 individual circular sets of briistles rotating three hundred sixty degrees (360) simultaneously. This motion of simultaneous movement is made possible by my unique sequential alignment of gears in my design of the Teethsweep-T electric toothbrush.
